(19) United States
(12) Patent Application Publication
(10) Pub. No.: US 2013/0239978 A1
(43) Pub. Date: Sep. 19, 2013

(54) DENTAL DEVICE

(71) Applicants: Michael Stubbs, Melbourne (AU); Jack Allen Gerschman, Melbourne (AU); Martin Szwarc, Melbourne (AU); David Penn, Point Piper (AU)

(72) Inventors: Michael Stubbs, Melbourne (AU); Jack Allen Gerschman, Melbourne (AU); Martin Szwarc, Melbourne (AU); David Penn, Point Piper (AU)

(73) Assignee: AIROSPACE ENTERPRISES PTY LTD, Melbourne (AU)

(21) Appl. No.: 13/821,827

(22) PCT Filed: Sep. 16, 2011
(86) PCT No.: PCT/AU11/01202

§ 371 Date: Jun. 5, 2013

(30) Foreign Application Priority Data
Sep. 16, 2010 (AU) 2010904180

(51) Int. Cl. A61C 5/14

(52) U.S. Cl. CPC A61C 5/14
USPC 128/861

(57) ABSTRACT

A dental device which comprises both an upper part fitted to the upper jaw of a wearer and a lower part fitted to the lower jaw of the wearer, wherein the upper part includes an upper magnet, the lower part includes a lower magnet, and the magnets are arranged so as to establish a magnetic repulsion between the magnets which opposes the closing of the jaw, thereby opposing direct contact between the upper part and the lower part.

### FIELD OF THE INVENTION

The invention relates to a dental device, and more particularly, but not exclusively, to a dental device for preventing a wearer from grinding his/her teeth during sleeping.

The invention relates to a dental device, and more particularly, but not exclusively, to a dental device for preventing a wearer from damaging his/her teeth during sleeping and for the treatment of TMD and headaches.

### BACKGROUND OF THE INVENTION

There is a known problem that people tend to grind their teeth, particularly during sleeping, causing damage to the teeth. Various attempts have been made to provide a dental appliance which can be used in the treatment of conditions including snoring, sleep apnea, temporomandibular joint pain, myofascial pain and bruxism. U.S. Pat. No. 7,712,468 discloses a magnetic dental appliance which uses magnetic force to advance the mandible to reduce bruxism forces. The dental appliance aims to reduce grinding and clenching so as to relieve muscle pain and reduce the frequency and severity of headaches associated with bruxism. More specifically, the dental appliance uses a magnetic component and a magnet-attracted element to magnetically engage the upper and lower arches. However, the applicant has determined that the positive engagement resulting from the magnetic attraction may limit relative movement of the jaws, and may not prevent excessive and detrimental forces between the jaws.

U.S. Pat. No. 4,396,373 discloses a magnetic orthodontic appliance for correcting magnetic force on live teeth, however the magnetic force from the device is directed towards only a limited number of teeth. Also, the device may not be readily removable by the patient, and the device does not prevent clenching.

Canadian Patent Application No. 2 484 059 discloses a dental appliance for treating malocclusions. The device is used for orthodontic movement of teeth to address tooth crowding, and has a protrusive effect on the mandible such that when the jaws are closed the mandible is driven forward. It deals with different issues to grinding and clenching, and would not be suitable for those purposes.

European Patent Application No. 0 543 335 relates to a denture for use on patients with no teeth, and uses magnets embedded in artificial teeth. The denture is not suitable for use in the treatment of temporo-mandibular disorder or in preventing grinding and clenching of a patient's teeth.

Examples of the present invention seek to provide a dental device which overcomes or at least alleviates one or more disadvantages associated with previous dental devices.

### SUMMARY OF THE INVENTION

In accordance with one aspect of the present invention, there is provided a dental device which comprises both an upper part fitted to the upper jaw of a wearer and a lower part fitted to the lower jaw of the wearer, wherein the upper part includes an upper magnet, the lower part includes a lower magnet, and the magnets are arranged so as to establish a magnetic repulsion between the magnets which opposes the closing of the jaw, thereby opposing direct contact between the upper part and the lower part.

Preferably, the magnets are arranged such that the magnetic repulsion is in a direction generally perpendicular to a plane of an arch of teeth of the upper and/or lower jaw. More preferably, the magnets are arranged such that the magnetic repulsion acts in a direction within 90 degrees of a direction perpendicular to the plane of the arch of teeth. Even more preferably, the magnets are arranged such that the magnetic repulsion acts in a direction within 30 degrees of a direction perpendicular to the plane of the arch of teeth.

Preferably, the magnets are arranged such that the magnetic repulsion is in a direction generally perpendicular to grinding surfaces of molars of the upper and/or lower jaw. More preferably, the magnets are arranged such that the magnetic repulsion acts in a direction within 90 degrees of a direction perpendicular to the grinding surfaces of said molars. Even more preferably, the magnets are arranged such that the magnetic repulsion acts in a direction within 30 degrees of a direction perpendicular to the grinding surfaces of said molars.

Preferably, the magnets are sufficiently strong such that, in use, the magnetic repulsion prevents or reduces all direct contact between the upper part and the lower part. More preferably, the magnets are rare earth magnets.

In a preferred example, the upper and lower parts are adapted to avoid positive engagement of the upper part relative to the lower part and to permit unrestrained lateral movement of the upper jaw relative to the lower jaw. More preferably, the upper and lower parts are free of inter-engaging components.

Preferably, the magnets are arranged such that the upper magnet is located directly above the lower magnet.

Alternatively, the magnets are arranged such that the upper magnet is located forward of the lower magnet. In another alternative, the magnets are arranged such that the lower magnet is located forward of the upper magnet.

In a preferred form, the upper part remains entirely above the lower when the upper and lower parts are brought together.

Preferably, the magnets are positioned in premolar regions of the upper and/or lower parts.

It is preferred that the upper part has a plurality of upper magnets, and the lower part has a plurality of lower magnets.

Preferably, each of the upper part and the lower part extends around the respective arch of teeth between magnets located at either side of the arch. More preferably, each of the upper part and lower part is arranged to contact each of the teeth of the respective arch between the magnets at either side of the arch. Each of the upper part and the lower part may be arranged to contact an outside surface of each tooth of the respective arch between the magnets at either side of the arch, the outside surfaces of the teeth being around the outside of the respective arch. In a preferred form, one or both of the upper part and the lower part is recessed to increase exposure of an outside surface of the front teeth.

It is preferred that the upper part is arranged to contact a lower incising/grinding surface of each tooth of the upper arch between the magnets at either side of the upper part, and the lower part is arranged to contact an upper incising/grinding surface of each tooth of the lower arch, between the magnets at either side of the lower part.

Preferably, each of the upper and lower parts includes a body moulded to substantially fully seal the magnet(s) within the material of the body. More preferably, each of the moulded bodies has a raised protrusion on each side to house the magnets at locations covering biting surfaces of the wearer's teeth.

In accordance with another aspect of the present invention, there is provided a method of treating bruxism including the step of wearing a dental device as described above.

### BRIEF DESCRIPTION OF THE DRAWINGS

The invention is described, by way of non-limiting example only, with reference to the accompanying drawings, in which:

FIG. 1 is a detailed cross-sectional view of portions of a dental device in accordance with one example of the present invention;

FIG. 2 is a detailed cross-sectional view of portions of a dental device in accordance with another example of the present invention using oval or parabola shaped magnets;

FIG. 3 is a detailed cross-sectional view of portions of a dental device in accordance with yet another example of the present invention, using disk shaped magnets;

FIG. 4 is a detailed cross-sectional view of portions of a dental device in accordance with another example of the present invention, using block shaped magnets;

FIG. 5 shows a range of magnet shapes which may be used in dental devices in accordance with other examples of the present invention;

FIG. 6 is a side front perspective view of a dental device in accordance with an example of the present invention;

FIG. 7 is a top front perspective view of the dental device shown in FIG. 6; and

FIG. 8 is a side perspective view of the dental device shown in FIGS. 6 and 7.

### DETAILED DESCRIPTION

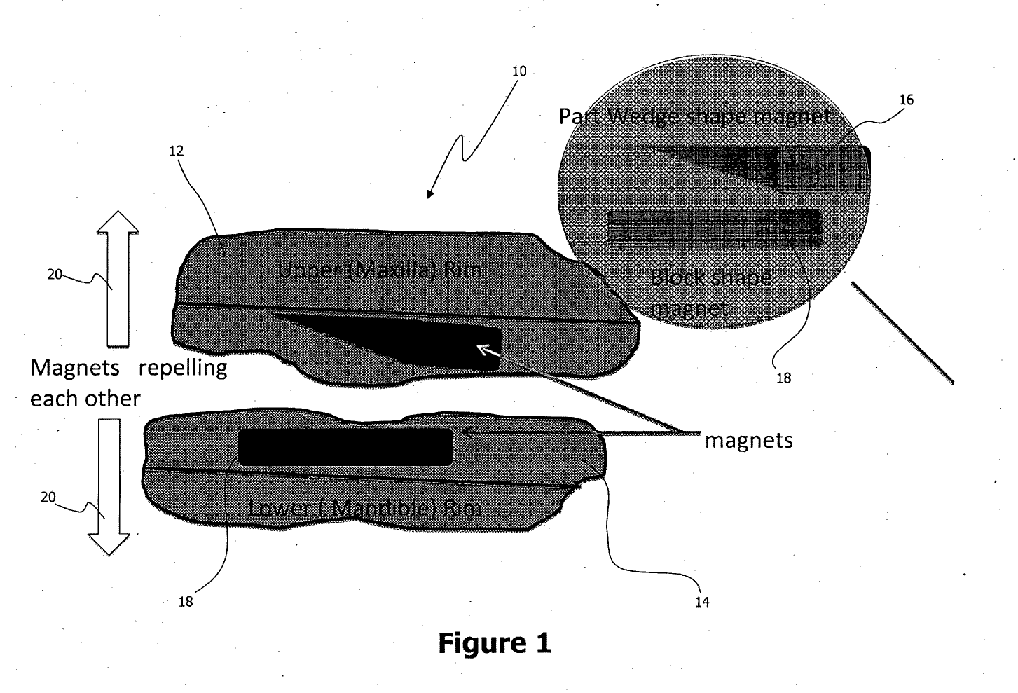

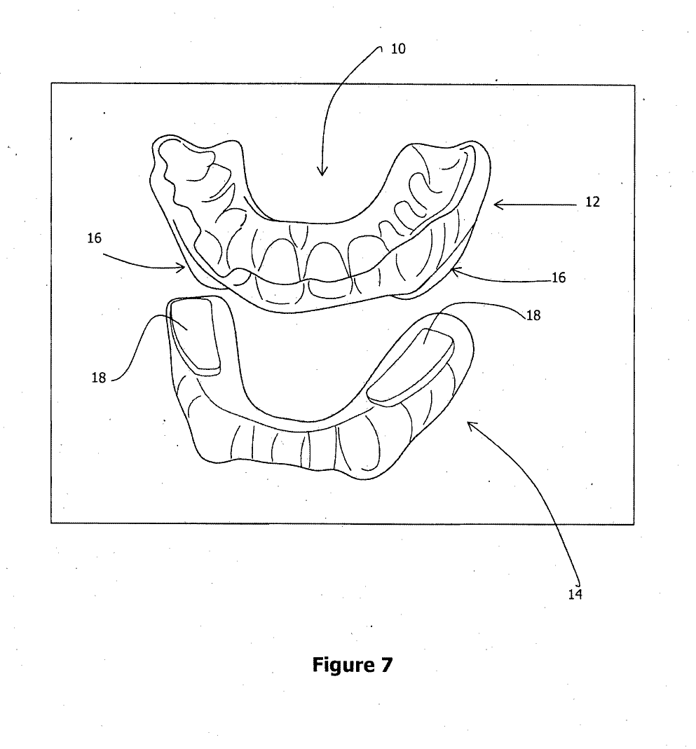

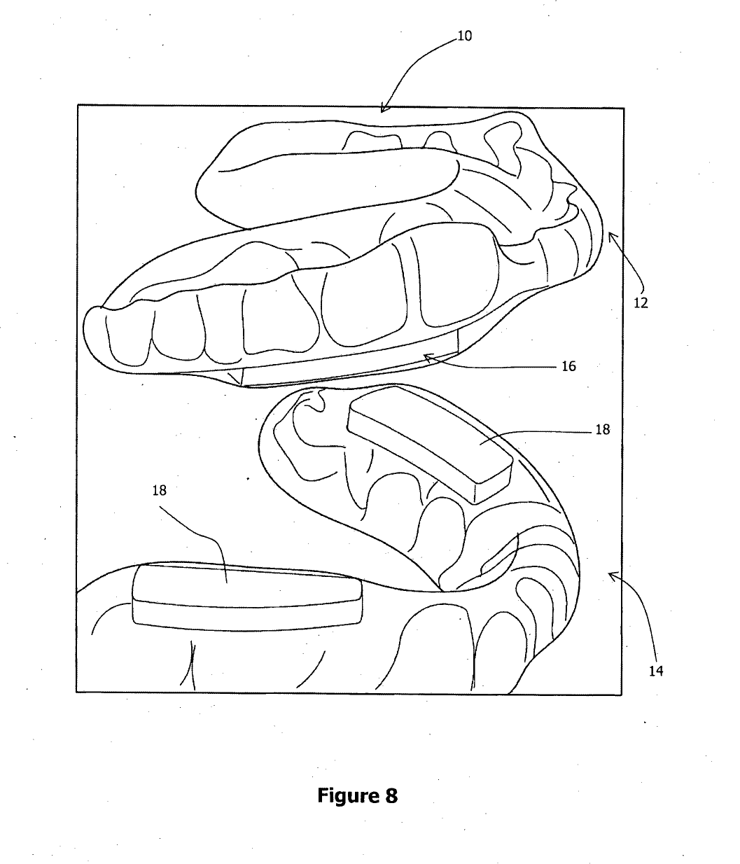

With reference to FIGS. 1 to 4 and 6 to 8 of the drawings, there are shown various examples of dental devices in accordance with the present invention, each of the examples being distinguished by the shape of the magnets used. With particular reference to FIG. 1, there is provided a dental device 10 which comprises both an upper part 12 fitted to the upper jaw of a wearer and a lower part 14 fitted to the lower jaw of the wearer. The upper part 12 includes an upper magnet 16, the lower part 14 includes a lower magnet 18, and the magnets 16, 18 are arranged so as to establish a magnetic repulsion between the magnets 16, 18 which opposes the closing of the jaw, thereby opposing direct contact between the upper part 12 and the lower part 14.

In the examples shown in FIG. 1, the upper magnet 16 is in the form of a part wedge shaped magnet, and the lower magnet 18 is in the form of a block shaped magnet. The upper part 12 fits over the upper jaw which is housed in the upper part 12 above the upper magnet 16. Similarly, the lower part 14 is fitted to the lower jaw which is housed in the lower part 14 below the lower magnet 18. In a preferred form, the magnets 16, 18 are positioned in premolar regions of the upper and lower parts 12, 14 such that the repelling forces of the magnets 16, 18 are transferred to the upper and lower jaws through these premolar and first molar regions.

The magnets 16, 18 are arranged such that the magnetic repulsion, indicated by arrows 20, is in a direction generally perpendicular to a plane of an arch of teeth of the upper and/or lower jaw. This may be achieved by careful positioning of the upper magnet 16 relative to the lower magnet 18 such that the magnetic repulsion acts in the desired direction, thereby opposing direct contact between the upper part 12 and the lower part 14. Advantageously, by opposing direct contact between the upper part 12 and the lower part 14, bruxism (clenching and grinding of the teeth) is prevented or at least reduced. Also, by maintaining the upper part 12 and the lower part 14 in spaced relationship, the forces transferred between the upper and lower jaws are greatly reduced, as the spacing between the jaws allows for gradual deceleration of any relative motion of one jaw toward the other. This is in contrast to existing dental devices which allow the upper and lower parts to come into direct contact such that there is a direct connection between the jaws.

Although in a preferred example the magnetic repulsion is in a direction generally perpendicular to the plane of the arch of teeth of the upper and/or lower jaw, such that there is little or no driven movement of the jaws in a lateral direction, in other examples of the invention the magnets may be arranged such that the magnetic repulsion acts in a direction within 90 (and more preferably 30) degrees of the direction perpendicular to the plane of the arch of teeth. This may be beneficial in cases where it is desirable for the wearer's jaws to be driven in a lateral direction in addition to the opposing of direct contact between the upper part 12 and the lower part 14.

The magnets 16, 18 may also be arranged such that the magnetic repulsion is in a direction generally perpendicular to grinding surfaces of molars of the upper and/or lower jaw. In particular, the magnets 16, 18 may be arranged such that the magnetic repulsion acts in a direction within 90 (and more preferably 30) degrees of a direction perpendicular to the grinding surfaces of said molars and premolar teeth. In most cases, the grinding surfaces of the molars will be in a plane generally parallel to the plane of the arch of teeth, however in some cases, the grinding surfaces of the molars may be tilted relative to the plane of the arch of teeth.

In preferred examples, the magnets 16, 18 are sufficiently strong such that, in use, the magnetic repulsion prevents or reduces all direct contact between the upper part 12 and the lower part 14. This may be achieved by using particularly strong permanent magnets, or by using other types of magnets such as, for example, electromagnets. The strength of the magnets may be chosen such that the magnetic repulsion is at least as strong as a typical force that the wearer is able to apply, or may apply inadvertently during sleep, such that all direct contact between the upper part 12 and the lower part 14 is prevented during normal use. The design force may be determined by way of experimentation and measurement of the force able to be applied by the wearer in closing his/her jaws.

The upper part 12 and the lower part 14 are adapted to avoid positive engagement of the upper part 12 relative to the lower part 14 to permit unrestrained lateral movement of the upper jaw relative to the lower jaw. In particular, this may be achieved by ensuring that no portions of the upper part 12 are capable of inter-engaging with portions of the lower part 14, during normal use. This is in contrast with previously proposed mandibular advancement devices which have specific inter-engaging portions which positive engage the upper part relative to the lower part during use such that there is direct contact between the parts. Although in other applications, such as in the design of mandibular advancement devices, it may be desirable to have direct contact between the upper and lower parts so as to effect driving forward of the lower jaw, the applicants have determined that for the prevention of grinding it is desirable for there to be no direct contact between the upper part 12 and the lower part 14.

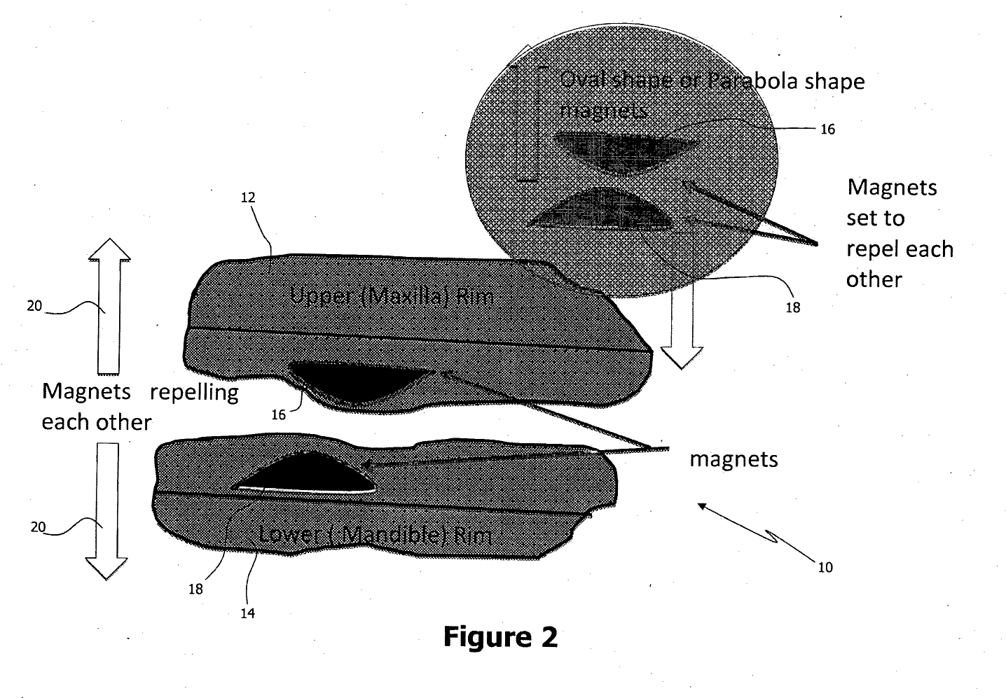

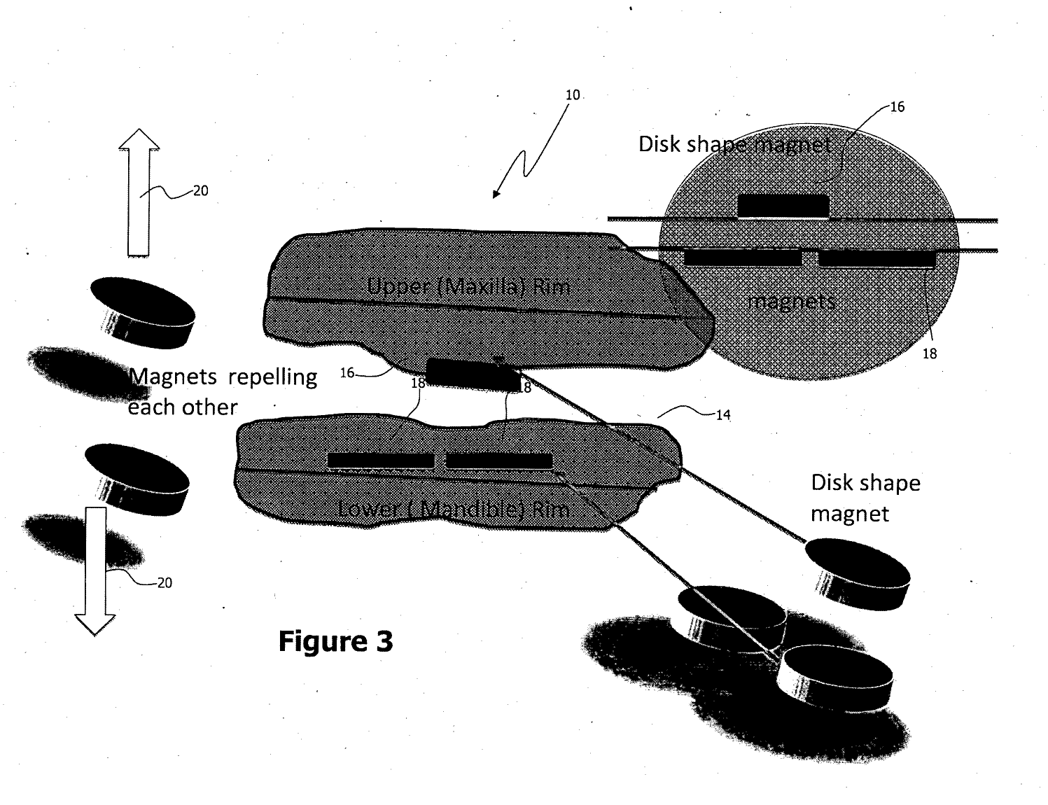

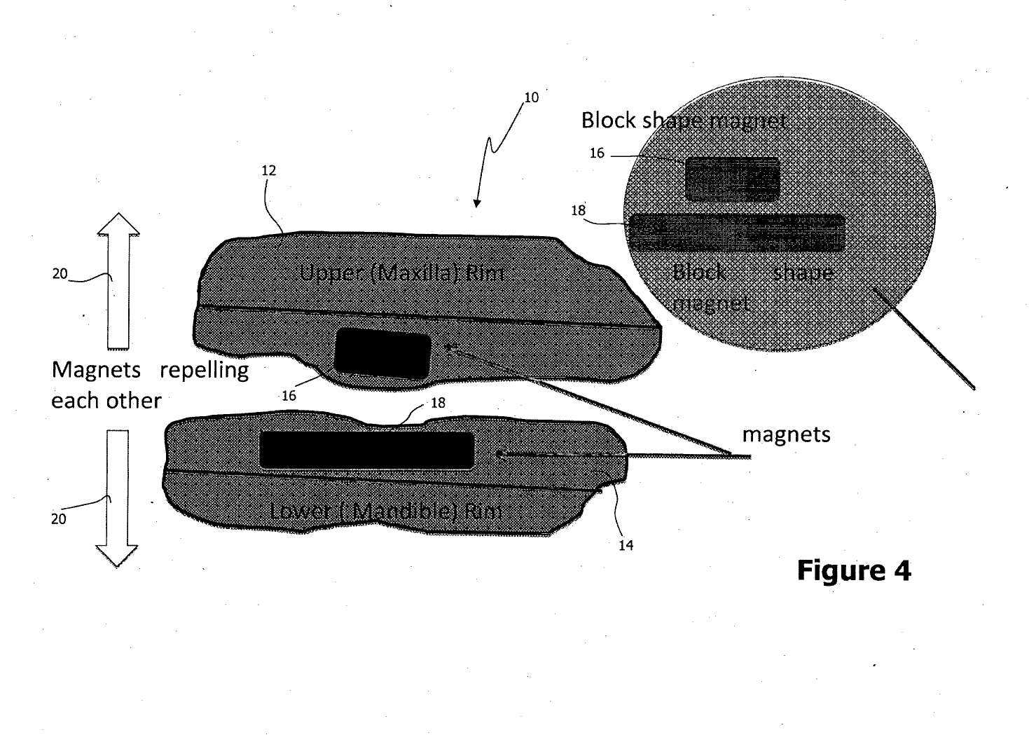

FIGS. 2 to 4 show alternative examples of the present invention in which differently shaped magnets 16, 18 are used. Aside from the shape of the magnets 16, 18, the dental devices 10 shown in FIGS. 2 to 4 are generally similar to the dental device 10 shown in FIG. 1, and like reference numerals are used to indicate like features. Specifically, the differences between the examples lie in that, as opposed to the example in FIG. 1 which uses a part wedge shaped upper magnet 16 and a block shaped lower magnet 18, the example in FIG. 2 uses oval shaped or parabola shaped upper and lower magnets 16, 18, the example shown in FIG. 3 uses disk shaped upper and lower magnets 16, 18, and the example in FIG. 4 uses block shaped upper and lower magnets 16, 18. Additionally, in the example shown in FIG. 3, there are two lower magnets 18 and a single upper magnet 16. It will be appreciated by those skilled in the art that the representations of FIGS. 1 to 4 show only one side of the dental device 10, and that the opposite side of the dental device 10 will be a mirror image of the representations shown. In particular, it will be understood that, in each case, the upper part 12 may have a plurality of upper magnets 16, and the lower part 14 may have a plurality of lower magnets 18.

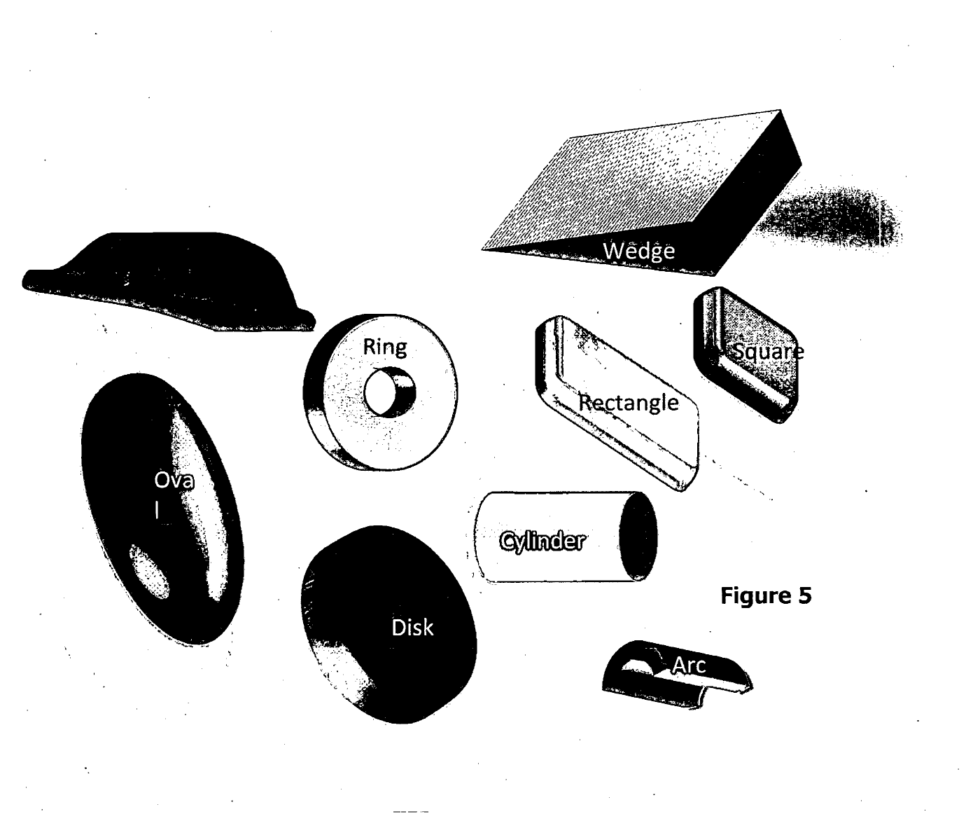

In examples of the present invention (see for example FIG. 4) the upper magnet 16 may be located directly above the lower magnet 18, such that there is little or no driven lateral movement of one jaw relative to the other. In one form, the magnets may be arranged such that the upper magnet 16 is located forward of the lower magnet 18. Alternatively, the magnets may be arranged such that the upper magnet 16 is located rearward of the lower magnet 18, thereby driving the lower jaw forward in addition to driving apart the jaws. The shaping of the magnets 16, 18 may be selected so as to achieve specific characteristics of the magnetic repulsion between the upper part 12 and the lower part 14, to obtain specific direction and magnitude of repulsion for specific relative locations of the upper and lower parts 12, 14. Examples of magnet shapes that may be used in examples of the present invention are shown in FIG. 5.

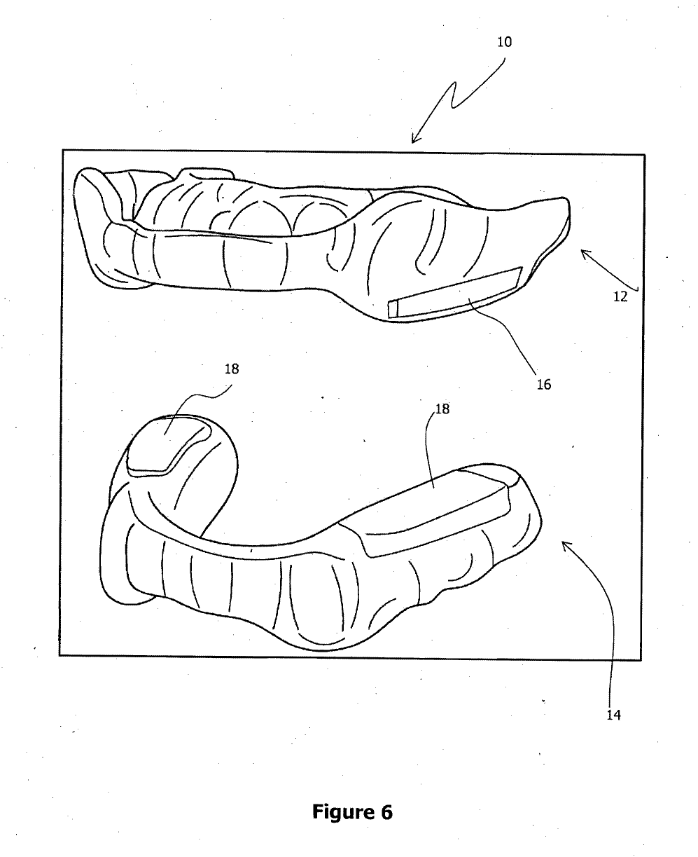

FIGS. 6 to 8 show yet another alternative example of the present invention in which differently shaped magnets 16, 18 are used. Aside from the shape of the magnets 16, 18, the dental device 10 shown in FIGS. 6 to 8 is generally similar to the dental device 10 shown in FIG. 1, and like reference numerals are used to indicate like features.

More particularly, the magnets 16, 18 are generally planar and are embedded within plastic moulded bodies which form the upper and lower parts 12, 14. The magnets 16, 18 are arranged so as to be between opposing teeth of the upper and lower jaws, so that the opposing forces of the upper and lower magnets act generally in directions which intersect the teeth above and below the respective magnets. The upper and lower parts 12, 14 may have bulbous raised protrusions to accommodate the magnets 16, 18 over the opposed surfaces of the teeth. The bulbous protrusions may completely encapsulate the magnets 16, 18 in a thickness of material sufficient to protect the magnets 16, 18 from damage, as magnets of sufficient strength for this application are typically quite fragile.

The magnets 16, 18 may be rare earth magnets so that they are sufficiently strong to prevent or reduce all direct contact between the upper part 12 and the lower part 14 when worn. The strength of the magnets 16, 18 may be chosen such that the magnetic repulsion is at least as strong as a typical force that the wearer is able to apply, or may apply inadvertently during sleep, such that all direct contact between the upper part 12 and the lower part 14 is prevented during normal use. In particular, the magnets 16, 18 may be neodymium magnets.

The upper part 12 and/or the lower part 14 may be cut away at the front so as to reduce coverage of front surfaces of the teeth which may facilitate comfort for the patient and, more particularly, facilitate more relaxed placement of the patient's lips.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A dental device when used for the treatment of bruxism, the device comprising both an upper part removably fitted to teeth of the upper jaw of a wearer and a lower part removably fitted to teeth of the lower jaw of the wearer, wherein the upper part includes an upper magnet, the lower part includes a lower magnet, and the magnets are arranged in use so as to establish and maintain a magnetic repulsion between the magnets which opposes the closing of the jaw, thereby opposing direct contact between the upper part and the lower part for the duration of normal use to prevent or at least reduce bruxism.

2. A dental device as claimed in claim 1, wherein the upper magnet is specifically located and oriented with respect to the upper part, and the lower magnet is specifically located and oriented with respect to the lower part, such that in use the upper magnet is located and oriented relative to the lower magnet so as to establish said magnetic repulsion which opposes direct contact between the upper part and the lower part to treat bruxism.

3. A dental device as claimed in claim 1, wherein the magnets are arranged such that the magnetic repulsion is in a direction generally perpendicular to a plane of an arch of teeth of the upper and/or lower jaw.

4. A dental device as claimed in claim 3, wherein the magnets are arranged such that the magnetic repulsion acts in a direction within 90 degrees of a direction perpendicular to the plane of the arch of teeth.

5. A dental device as claimed in claim 4, wherein the magnets are arranged such that the magnetic repulsion acts in a direction within 30 degrees of a direction perpendicular to the plane of the arch of teeth.

6. A dental device as claimed in claim 1, wherein the magnets are arranged such that the magnetic repulsion is in a direction generally perpendicular to grinding surfaces of molars of the upper and/or lower jaw.

7. (canceled)

8. A dental device as claimed in claim 7, wherein the magnets are arranged such that the magnetic repulsion acts in a direction within 30 degrees of a direction perpendicular to the grinding surfaces of said molars.

9. A dental device as claimed in claim 1, wherein the magnets are sufficiently strong such that, in use, the magnetic repulsion prevents all direct contact between the upper part and the lower part.

10. A dental device as claimed in claim 1, wherein the magnets are rare earth magnets.

11. A dental device as claimed in claim 1, wherein the upper and lower parts are adapted to avoid positive engagement of the upper part relative to the lower part to permit unrestrained lateral movement of the lower jaw relative to the upper jaw.

12. A dental device as claimed in claim 11, wherein the upper and lower parts are free of inter-engaging components.

13. A dental device as claimed in claim 1, wherein the magnets are arranged such that the upper magnet is located above the lower magnet.

14. A dental device as claimed in claim 1, wherein the magnets are arranged such that the upper magnet is located either above or rearward of the lower magnet.

15. A dental device as claimed in claim 1, wherein the upper part remains entirely above the lower part when the upper and lower parts are brought together.

16. A dental device as claimed in claim 1, wherein the magnets are positioned in premolar to first molar regions in both the upper and lower parts.

17. A dental device as claimed in claim 1, wherein the upper part has a plurality of upper magnets, and the lower part has a plurality of lower magnets.

18. A dental device as claimed in claim 1, wherein each of the upper part and the lower part extends around the respective arch of teeth between magnets located at either side of the arch.

19. (canceled)

20. (canceled)

21. (canceled)

22. (canceled)

23. (canceled)

24. A dental device as claimed in claim 1, wherein moulded bodies of the upper and lower parts each have a raised protrusion on each side to house the magnets at locations covering biting surfaces of the wearer's teeth.

25. A method of treating bruxism including the step of wearing a dental device as claimed in claim 1 to prevent or at least reduce contact between the upper and lower jaws.

26. A method of treating bruxism including the steps of:
locating and orienting an upper magnet with respect to an upper part of a dental device;
locating and orienting a lower magnet with respect to a lower part of the dental device;
removably fitting the upper part to teeth of an upper jaw of a wearer; and
removably fitting the lower part to teeth of a lower jaw of the wearer;
wherein said locating and orienting of the magnets is conducted such that, when in use, the upper magnet is located and oriented relative to the lower magnet so as to establish and maintain a magnetic repulsion between the magnets which opposes the closing of the jaws, thereby opposing direct contact between the upper part and the lower part for the duration of normal use to treat bruxism.
